(19) United States
(12) Patent Application Publication
(10) Pub. No.: US 2017/0299166 A1
(43) Pub. Date: Oct. 19, 2017

(54) Method and Apparatus for Hands Free Self-Activating Flashlight

(71) Applicant: Life+Geat, San Diego, CA (US)

(72) Inventor: Todd Pazdur, Encinitas, CA (US)

(73) Assignee: Life+Gear, San Diego, CA (US)

(21) Appl. No.: 15/099,032

(22) Filed: Apr. 14, 2016

(51) Int. Cl. F21V 23/04; H05B 37/02; F21L 4/00; F21L 4/02

(52) U.S. Cl. CPC F21V 23/0464; H05B 37/0218; F21L 4/022; F21L 4/005; F21V 23/0414

(57) ABSTRACT

An inventive flashlight capable of operating in an automatic hands free and self-activating mode that is response to an ambient light conditions about the flashlight. This self-activating flashlight includes a body, a light source directing a light output from one end of the flashlight body, a power source, an ambient light sensor responsive to ambient light conditions and a control circuit electrically connected to the ambient light sensor and the light source. In one mode of operation the light output of the light source is regulated in proportion to the amount of ambient light present, wherein the light source provides proportionally more light output as ambient light decreases and proportionally less light, to fully turning off, as the ambient light increases.

### BACKGROUND OF THE INVENTION

The present invention pertains to illumination devices and, more particularly, to hand held illumination devices more commonly referred to as flashlights.

Flashlight have ubiquitous applications for providing transportable illumination, both at night and during the day in spaces subject to little or no lighting. Such venues may include the basement or attic of a home or some form of industrial site such as a factory or underground work site. A wide variety of professionals and workers require use of a flashlight during their regular work day as they move from adequately illuminated settings to darker settings where additional illumination is required. Examples include, among others, professional inspectors such as home inspectors and civil engineers inspecting a work site. Conventional flashlights typically possess a simple on/off switch, which must first be switched on when moving from an adequately illuminated setting to one that is inadequately illuminated, and then must be switched “off” when moving back into an adequately illuminated setting. While it's not absolutely essential to switch the flashlight back off again, battery life suffers if the flashlight is not switched off when additional illumination is no longer required. In a number of instances the flashlight user, such as a professional inspector may inadvertently forget to deactivate their flashlight in the excitement of what they have discovered in the inadequately illuminated inspection site. Sometimes, seemingly frequently, this forgetfulness results in the flashlight being irritatingly inoperative until the batteries are replaced.

Thus, there still exists a need for a flashlight that doesn't have to be turned on and off as a user moves from adequately to inadequately illuminated venues but which still preserves battery life over simply leaving the flashlight on.

Flashlights are also almost invariably the first go-to item during a power failure occurring at night or in venues having little or no natural illumination, such as windowless settings. One problem persists in such settings, finding the flashlight when a venue is reduced to inadequate illumination or total darkness due to the power failure. Emergency devices do exist to address this problem, but such flashlights require connection to the existing power grid in order to monitor the status of the power grid and activate the flashlight in the event of a power failure. This connection requirement limits the available placement of the flashlight to locations capable of providing this connection. One such device, for example, must be plugged into an electrical wall socket. Thus, there still exists a need for a flashlight that can be found when a venue is suddenly plunged into darkness during a power failure but which does not also require connection to the power grid or a wall socket.

### BRIEF SUMMARY OF THE INVENTION

The present invention provides a flashlight overcoming the above mentioned deficiencies by providing hands free automatic activation and deactivation based upon ambient light conditions. The present invention allows users to move from adequately illuminated to inadequately illuminated settings and back again without having to manually activate the flashlight, thereby saving battery power and avoiding annoyance in many work settings. The flashlight of the present invention will also self-activate when in an ambient light sensing mode if the venue in which the flashlight resides is suddenly plunged into inadequate illumination or effectively total darkness. In one embodiment the flashlight of the present invention further includes a low-powered secondary light source that is activated when the present invention is in an ambient light sensing mode. This secondary source provides an easy means of determining when the flashlight of the present invention is operating in an ambient light sensing mode and further facilitates users finding this inventive flashlight in dark or pitch black setting resulting from a power failure.

To attain these goals and advantages the present invention generally comprises a flashlight including a flashlight body, a light source directing a light output from one end of the flashlight body, a power source, an ambient light sensor responsive to ambient light conditions and a control circuit electrically connected to the ambient light sensor and the light source that is configured to enable control of the output of the light source in response to ambient light conditions.

In one preferred embodiment the control circuit enables the ambient light sensor to regulate the light output of the light source in proportion to the amount of ambient light, wherein the light source provides proportionally more light output as ambient light decreases. In another embodiment the flashlight body defines a rim at a forward light bearing end of the flashlight and the ambient light sensor is mounted on this rim. In yet another embodiment the rim of the flashlight body forms at least one depression and the ambient light sensor is mounted in this depression. In a further embodiment of the present invention the flashlight of the present invention includes an off/on switch and the control circuit is configured to be responsive to operation of said switch to energize the light source and enable control of its output in response to ambient light conditions in a first mode and deactivate the light source in a second mode. In still another embodiment of the present invention the control circuit includes a third mode of operation, responsive to the operation of said switch, in which the light source is activated at a constant output nonresponsive to ambient light conditions. Yet a further embodiment of the present invention includes a secondary light source mounted on the flashlight to indicate when the control circuit is operating in the first mode.

The foregoing, and further advantages, features and principles of the present invention will become more readily apparent from the following detailed description of several preferred embodiments of the present invention that follows below with reference to the accompanying drawings.

### BRIEF DESCRIPTION OF THE DRAWINGS

FIG. 1 is a front perspective view of the flashlight of the present invention according to one preferred embodiment thereof.

FIG. 2 is a further perspective view of the forward light output end of one preferred embodiment of the flashlight of the present invention.

FIG. 3 is a partial exploded side view of one preferred embodiment of the present invention.

FIG. 4 is a schematic view of the flashlight control circuit in one preferred embodiment of the present invention.

### DETAILED DESCRIPTION

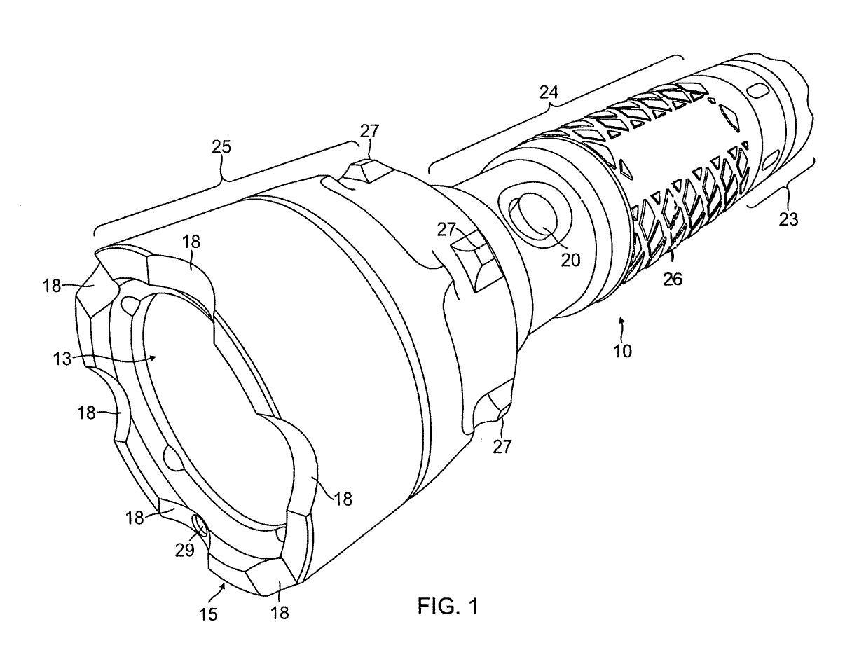

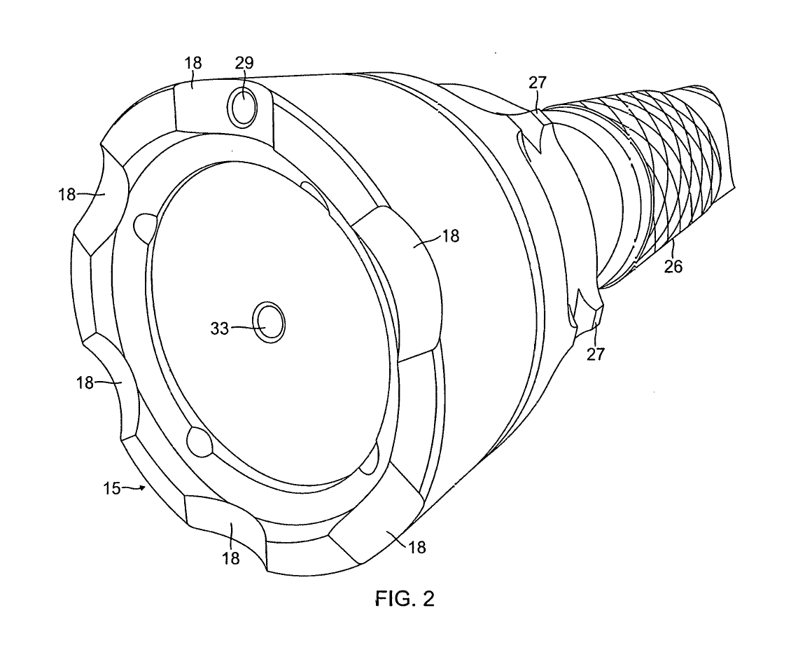

Referring to the figures, and more particularly FIG. 1 and FIG. 2 thereof, there is shown one preferred embodiment of the hands free self-activating flashlight of the present invention. As shown, the flashlight of the present invention includes a flashlight body 10 having a forward light output end 13. The flashlight body 10 further defines a rim 15 which, in one preferred embodiment, defines at least one depression 18 in the rim. In the preferred embodiment illustrated in FIG. 1 the rim 15 defines a plurality of depressions 18. As shown, the depression 18 may be, preferably but not necessarily, dimensioned so as to further communicate with an edge of the flashlight body 10 generally perpendicular to the rim 18 of the flashlight body 10. The flashlight also includes a switch 20 mounted within a counter-sunk bore 22 in the body 10. This switch 20 is configured to provide user input for various modes of operation of the flashlight by depressing the switch. The flashlight also includes an end cap assembly 23 for access to the power source stored within the body of the flashlight.

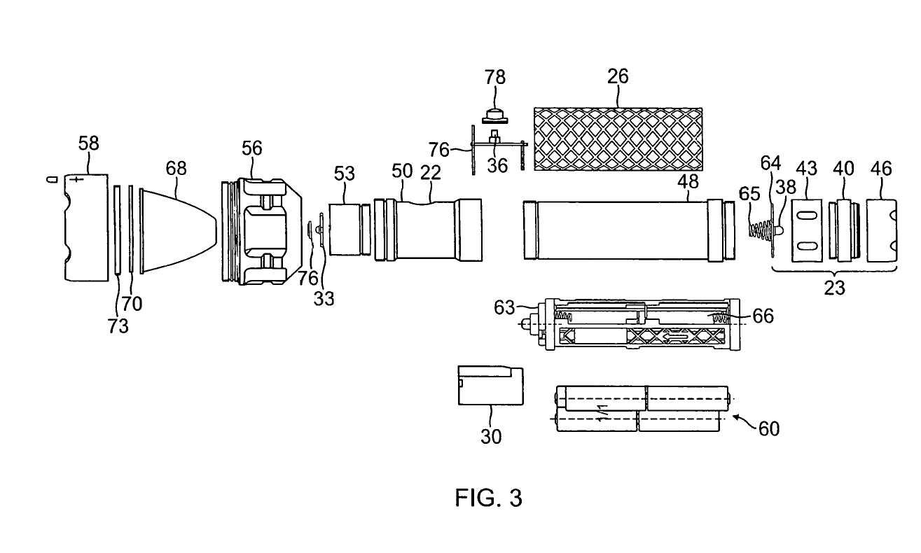

In one preferred embodiment the flashlight body 10 has a first diameter portion 24 having a diameter configured to comfortably fit within most user's hands and a second diameter portion 25 having a second diameter designed to accommodate a reflector 68 (see FIG. 3), described further below. The first diameter portion 24 may further be provided with a resilient knurled material 26 to facilitate a user's hold or grip on the flashlight body 10. The second diameter portion 25 may also be configured to provide one or a plurality of protrusions 27. These protrusions provide an anti-roll function when the flashlight body 10 is laid on its side on a flat surface. Alternatively, of course, in alternative embodiments the flashlight body 10 may have a single first diameter along its entire length.

In accordance with one aspect of the present invention, an ambient light sensor 29 is mounted on the body of the flashlight body 10. In one preferred embodiment this ambient light sensor 29 is mounted in one of the depressions 18 in the rim 15 of the flashlight. While it is within the spirit and scope of the present invention to mount the ambient light sensor 29 at other locations on the flashlight body 10, such as for example the end cap assembly 23, the inventors have determined the most effective location for placement of the ambient light sensor 29 is on the forward rim 15 of the flashlight body 10. By configuring the depressions 18 as described above, communicating with an edge of the flashlight body 10 generally perpendicular to the rim 15, and by mounting the ambient light sensor 29 within the depression 18 the ambient light sensor is able to respond to ambient light levels about the flashlight even when the flashlight body 10 is placed with the rim 15 face down on a flat surface, such as a desk or table, and in direct contact therewith.

In one embodiment of the present invention a control circuit 30 (see FIG. 3) is configured to activate the output of a light source 33 (see FIG. 2) dependent upon the number of times a user presses the switch 20. In a first mode of operation, selected by a user by pressing the switch a first time, the output of the light source 33 is made responsive to ambient light conditions about the flashlight body 10. By pressing the switch a second time, however, the flashlight of the present invention may be placed in an second mode where the flashlight is still activated but is not responsive to ambient light conditions.

When the flashlight body 10 is placed in a first ambient light sensing mode and located in an ambient light environment having sufficient illumination the ambient light sensor 29 will sense this level of illumination and the light source 33 will not activate. If, however, while in this mode of operation the flashlight is moved to another location having inadequate lighting, then the ambient light sensor 29 will sense the reduction in ambient light and the light source 33 will activate without requiring further user input. Further, if the flashlight is removed from the location having inadequate ambient lighting into one having adequate illumination, then the ambient light sensor 29 will again sense the increase in illumination and the light source 33 will be deactivate without user input. Thus, in this mode of operation users of the present inventive flashlight may move from adequately illuminated settings to inadequately illuminated settings and back again with the flashlight effectively activating and deactivating the light source 33 without user input. Normally the light source 33 is the most power consumptive element of the flashlight, thus in accordance with the present invention power consumption may be regulated without user input, but instead based upon ambient lighting conditions as detected by the ambient light sensor 28.

Alternative to moving the flashlight from adequately illuminated to inadequately illuminated settings, if the flashlight body 10 is in an ambient light environment having sufficient illumination such that the light source 33 is not active and if the ambient light environment becomes less illuminated, resulting for example from a power failure, then the ambient light sensor 29 will again detect this decrease in illumination and again the light source 33 will be activated without user input. This mode of operation facilitates the flashlight automatically providing illumination during a power failure without user input, and a capability of doing so without requiring the flashlight to be plugged into or otherwise electrically connected to a wall socket or the power grid.

In one preferred embodiment the switch 20 is provided with a secondary light source 36 (see FIG. 3) which is energized when the flashlight of the present invention is activated to operate in a first mode responsive to ambient light conditions as described immediately above. This secondary light source may, for example, be a low power LED element. By activating this secondary light source 36 when the flashlight of the present invention is in an ambient light sensing mode, a simple visual cue is afforded to determine whether the flashlight is in a mode to self-activate when the ambient light sensor 29 senses inadequate lighting conditions.

Of course, it is with the spirit and scope of the present invention to include additional modes of operation for the flashlight of the present invention. For example, in one embodiment of the present invention the control circuit 30 may be configured to count the number of times a user depresses the switch 20 within a predetermined period of time to afford additional modes of operation. One such mode of operation may be a “high” beam output from light source 33 which is “always on” that is, not responsive to the level of illumination detected by the ambient light sensor 29. A further mode of operation, also activated by an additional depression of the switch 20, may be a “low” beam output from light source 33 which is also “always on” irrespective of the level of ambient illumination detected by the ambient light sensor 29. This “low” beam output, while providing reduced lighting compared to the “high” beam output, also consumes less power and thus prolongs battery life compared to the “high” beam rate of consumption.

In accordance with yet another preferred embodiment of the flashlight of the present invention may further be provided with an additional light source 38 in the end cap assembly 23 as shown in FIG. 3. To accommodate this additional light source 38, the end cap assembly 23 may be comprised of a light translucent portion 40 disposed between non-translucent portions 43 and 46 to afford a path for light emanating from the additional light source 38 to reach the exterior of the flashlight body 10. The inventors have determined there are advantages to providing this additional light source 38 in the end cap assembly 23. This additional light source may be used, for example, by the flashlight user to signal other people in darkened lighting conditions without having to direct the output beam of the light source 33 either at these others or at some nearby surface. Directing the light output in this fashion has the potential to reduce the dark adapted vision of others in dimly lit situations. This additional light source 38 may also be activated by the control circuit 30 in response to a predetermined number of presses of the switch 20 by the flashlight user.

FIG. 3 is a partial exploded view of one preferred embodiment of the present invention. As shown, the flashlight body 10 may actually be comprised of a number of separate elements 48, 50, 53, 56 and 58 that either threadingly engage one another or, alternatively, are configured to slip fit into one another and subsequently be bonded in place. Alternatively, of course, the flashlight body 10 may be machined from fewer, or even a single, piece(s) of suitable material, such as aluminum or, in an alternative embodiment, made from another suitable material such as composite materials or plastic compositions without departing from the spirit and scope of the present invention.

As shown in FIG. 3, power for activation of the light source 33 and for supplying electrical power to the other flashlight elements such as control circuit 30, secondary light source 36 and additional light source 38 is provided by a plurality of batteries 60. These batteries 60 are mounted in a battery holder 63 configured to retain the batteries 60 in spring biased receptacles 66. Battery holder 63 is further configured to slidingly fit within the flashlight body 10, as is known in the flashlight art. Alternatively, larger sized batteries could be used and the battery holder 63 would no longer be required. As further illustrated, the additional light source 38 is mounted on a structure 64 configured to fit within the non-translucent portion 43 of the rear end cap assembly 23. A spring 65 is also attached to structure 64 to bias the battery holder 63 within the flashlight body 10.

FIG. 3 further illustrates reflector 68 for shaping the light output of the light source 33 as is also known in the flashlight art. As shown, reflector 68 is mounted within the forward light output end 13 of the flashlight of the present invention, along with an essentially light transparent window 70 and gasket 73 intended to provide a water resistant seal between the window 70 and the light output end 13 of the flashlight body 10 all as are also well known in the flashlight art. Also shown in FIG. 3 is the light source 33 which may be provided with a focusing element 76. While preferred embodiments of the present invention utilize LED elements for the light source 33 as is well known in the flashlight art, it could of course to possible to use filament elements without departing from the spirit or scope of the present invention. The control circuit 30, also shown in FIG. 3, is configured to fit within the flashlight body 10 immediately behind the reflector 68 and light source 33.

As is also known in the flashlight art, user operated switch 20 and the secondary light source 36 may comprise a unitary structure configured to fit within the counter-sunk bore 22 in the flashlight body 10. This unitary structure, including secondary light source 36, may be mounted on a frame 76 configured to fit within the flashlight body 10. A flexible and translucent cover 78 may also be provided to cover the unitary structure including the switch 20 and secondary light source 36 so as to afford a water resistant seal over this unitary structure. This cover 78 may be either pressed or biased against an inner surface of the flashlight body 10 by the frame 76 or, alternatively, bonded to the flashlight body 10.

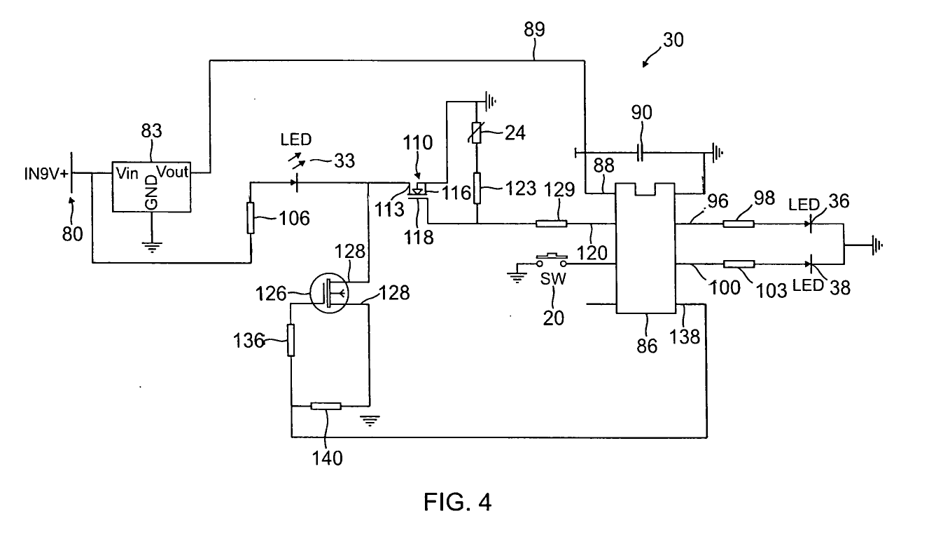

A control circuit for controlling operation of the flashlight of the current invention in one preferred embodiment is shown if FIG. 4. In this embodiment electrical power from a positive terminals of the batteries 60 is supplied to an input 80. A voltage conditioner 83 supplies a suitable voltage to a power input 88 of programmed control chip 86 through conductive path 89. The control chip 86 further includes an output 90 coupled to ground. A capacitor 93 may be provided, bridging the power input 88 and output 90 of the control chip 86. In this embodiment the control chip 86 is provided with several signal output, including output 96 connected to the secondary light source 36 through an appropriate resistor 98 and an output 100 connected to the additional light source 38 through resistor 103. As further shown, a further input 99 to control chip 86 is connected to switch 20.

As also illustrated in FIG. 4, power to the light source 33 is supplied from input 80 through bifurcating electrical paths. One path is connected to a solid state switch 110 having a variable conductance dependent upon the ratio of charge applied between a drain 116 and gate 118 of switch 110. Such variable conductance solid state switches are well known in the electronic arts and may comprise a MOSFET-type operational amplifier or similar solid state device. Switch 110 has an source 113 connected to the light source 33 and the drain 116 is connected to ground, affording a current path from the power input 80 through the light source 33 to ground through the solid state switch 110. The gate 118 for solid state switch 108 is connected to an additional output 120 of control chip 86 through resistor 123. In addition, the ambient light sensor 29 bridges the drain 116 and the gate 118 of switch 110 in serial with a resistor 124.

A separate electrical path for light source 33 is afforded through a solid state tri-state switch 126. This tri-state switch 126 has a source 128 connected to the light source 33 and a drain 130 connected to ground. This configuration affords a current path from the power input 80 through the light source 33 to ground through switch 126 that is separate from the current path through switch 110. The gate 133 of tri-state switch 126 is connected via resistor 136 to a further output 138 of the control chip 86. A resistor 140 further bridges the drain 130 and gate 133 of tri-state switch 126 in series with resistor 136 as is generally well known in the electronics arts.

In operation, the control chip 86 regulates operation of the light source 33 in response to the number of times a user activates switch 20. The control chip 86 may activate either switch 110 or, alternatively, activate tri-state switch 126 to provide a completed conductive path from the power input 80 to ground through the light source 33. High and low output beams for the flashlight of the present invention are provided by control chip 86 deactivating switch 110 and activating tri-state switch 126 in either of a first or second conductive state. Tri-state switches are also well known in the electronics arts.

When the flashlight of the present invention is to operate in a light sensing mode, tri-state switch 126 is deactivated and switch 110 is activated. In one preferred embodiment of the present invention, activation of switch 110 is achieved by control chip 86 providing a “high” or positive voltage signal to gate 118 of solid state switch 110. In this embodiment the flashlight of the present invention is then responsive to ambient light conditions by ambient light sensor 29 becoming more conductive in response to increasing levels of ambient illumination, thus grounding the gate 118 of the solid switch 110 and rendering the switch 110 non-conductive. As mentioned above the conductance of switch 110 may be made to vary in relation to the ratio of charge applied between the drain 116 and gate 118 of switch 110. By employing a photoresistor as the ambient light sensor 29, the conductivity of switch 110 may then be efficaciously made to vary proportionally with the magnitude of illumination detected by the photoresistor-type ambient light sensor 29. In this configuration as the resistance of the photoresistor-type ambient light sensor varies, so to does the voltage ratio between the gage 118 and drain 116 of the switch 110 proportionally vary. As a consequence thereof the light source 33 can be made to provide proportionally more output as the magnitude of ambient light decreases and to provide proportionally less light output as the magnitude of ambient light increases until the photoresistor-type ambient light sensor 29 effectively grounds gate 118 of switch 110, rendering switch 110 non-conductive and effectively turning the flashlight of the present invention “off” without further user input.

Having described and illustrated the present invention in various preferred embodiments, it should be readily apparent to those skilled in the relevant arts that the present invention can be modified in arrangement and detail to provide numerous other embodiments that do not depart from the spirit and scope of this invention. For example, the tri-state switch 126 could be replaced with two separate bi-state switches connected in parallel to light source 33 without departing from the scope of the present invention. Alternatively, the flashlight of the present invention could simply be provided with a single output mode nonresponsive to ambient light conditions, in which instance tri-state switch could be replaced with a simple bi-state type solid state switch. Accordingly, all equivalent relationships to those illustrated in the drawings and described in the specification above are intended to be encompassed within the scope of the present invention, s set forth in the claims below and equivalents thereof.

It is to be further understood that the phraseology and terminology employed herein are for the purposes of description only and should not be regarded as limiting the scope of the present invention. Therefore, the foregoing description of the present invention is to be considered as illustrative only of the principles of the present invention. Further, since numerous modifications, changes and alternative embodiments will occur to those skilled in the art, the present invention is not to be limited to the structures, elements, construction and operation shown and described above, but solely by the claims set forth below and equivalents thereof.

What is claimed is:

1. A flashlight capable of responding to ambient light conditions, comprising:
a flashlight body;
a light source attached to said flashlight body and capable of providing a light output;
a power source attached to said flashlight body;
an ambient light sensor, attached to said flashlight body, responsive to ambient light conditions; and
a control circuit, electrically connected to said light source, configured to selectively enable control of the light output of said light in response to ambient light conditions.

2. The flashlight of claim 1 wherein said control circuit enables regulation the light output of said light source in proportion to the amount of ambient light, wherein the light source provides proportionally more light output as ambient light decreases.

3. The flashlight of claim 1 wherein said flashlight body defines a edge at one end of said flashlight body and wherein said ambient light sensor is mounted on said edge.

4. The flashlight of claim 3 wherein the edge of said flashlight body further defines at least one depression and wherein said ambient light sensor is mounted in said depression.

5. The flashlight of claim 1 further comprising a switch mounted on said flashlight body and wherein said control circuit is configured to be responsive to operation of said switch so to enable control of the light output of said light source in response to ambient light in a first mode and to deactivate said light source in a second mode.

6. The flashlight of claim 5 wherein said control circuit is further configured to be responsive to operation of said switch to activate said light source at a constant output nonresponsive to ambient light in a third mode.

7. The flashlight of claim 5 further comprising a secondary light source attached to said flashlight body and wherein said control circuit activates said secondary light source when said control circuit is operating in said first mode.

8. A flashlight having a light output responsive to ambient light conditions, comprising:
a flashlight body defining a forward light output end with a rim;
a light source mounted on said flashlight body so as to project light from the forward light output end of said flashlight body;
a switch attached to said flashlight body;
a power source attached to said flashlight body;
an ambient light sensor attached to the rim of said flashlight body responsive to the magnitude of ambient light; and
a control circuit responsive to operation of said switch so as to enable control of the output of said light source in response to said ambient light sensor.

9. The flashlight of claim 8 wherein said flashlight body defines a rim at the forward light output end of said flashlight body and further defines at least one depression facing out of the forward rim of said flashlight body, wherein said ambient light sensor is mounted in said depression.

10. The flashlight of claim 8 wherein said control circuit is configured to enable regulation the output of said light source in proportion to the amount of ambient light, whereby the light source provides proportionally more output light as ambient light decreases.

11. The flashlight of claim 8 further wherein said control circuit is configured to be responsive to operation of said switch so to enable control of the light output of said light source in response to ambient light in a first mode and to deactivate said light source in a second mode.

12. The flashlight of claim 11 further comprising a secondary light source attached to said flashlight body and wherein said control circuit activates said secondary light source when said control circuit is operating in said first mode.

13. The flashlight of claim 8 wherein said control circuit is further configured to be responsive to operation of said switch to activate said light source at a constant output nonresponsive to ambient light in a third mode.

14. A flashlight having a light output responsive to ambient light, comprising:
a flashlight body defining a forward light output end with a rim, said rim further defining a depression facing out of said rim, said depression further communicating with an edge of said flashlight body generally perpendicular to the rim of said flashlight body;
a light source mounted on said flashlight body so as to project light from the forward light output end of said flashlight body;
a power source attached to said flashlight body;
an ambient light sensor mounted within the depression of said flashlight body responsive to the ambient light; and
a control circuit electrically connected to said ambient light sensor and said light source, said control circuit enabling the output of said light source in response to said ambient light sensor.

15. The flashlight of claim 14 wherein said control circuit regulates the output of said light source in proportion to the amount of ambient light whereby the light source provides proportionally more light output as ambient light decreases.

16. The flashlight of claim 14 further comprising a switch mounted on said flashlight body and wherein said control circuit is configured to be responsive to operation of said switch to energize said light source and control the output of said light source in response to ambient light conditions in a first mode and to deactivate said light source in a second mode.

17. The flashlight of claim 16 further comprising a secondary light source attached to said flashlight body and wherein said control circuit activates said secondary light source when said control circuit is operating in said first mode.

18. The flashlight of claim 16 wherein said control circuit is further responsive to operation of said switch to activate said light source at a constant output nonresponsive to output from said ambient light sensor in a third mode.

19. The flashlight of claim 16 wherein said control circuit is further configured to be responsive to operation of said switch to activate said light source at a constant output nonresponsive to ambient light in a third mode.
